(19) United States
(12) Patent Application Publication
(10) Pub. No.: US 2013/0064523 A1
(43) Pub. Date: Mar. 14, 2013

(54) VIDEO SERVER, VIDEO RECORDING METHOD AND METHOD FOR CONTROLLING REBUILDING PROCESS

(71) Applicants: Toshiki Mori, Tokyo (JP); Hiroyuki Watanabe, Tokyo (JP); Naoko Satoh, Tokyo (JP)

(72) Inventors: Toshiki Mori, Tokyo (JP); Hiroyuki Watanabe, Tokyo (JP); Naoko Satoh, Tokyo (JP)

(21) Appl. No.: 13/561,484

(22) Filed: Jul. 30, 2012

(30) Foreign Application Priority Data
Sep. 9, 2011 (JP) P2011-197592

(51) Int. Cl. H04N 9/80

(52) U.S. Cl. 386/248; 386/239; 386/E09.011

(57) ABSTRACT

According to one embodiment, a video server including a recording device configured to encode a received video signal based on a predetermined encoding method into video data; a write controller configured to divide the video data in order to generate a plurality of divided data, generate a redundant data for restoring either of the divided data of the number of setup when the divided data of the number of setup in advance, perform write-in controlling of the plurality of divided data and the plurality of redundant data; a plurality of storage devices configured to record the number of setup of divided data and the redundant data based on the divided data of the number of setup by distributing herein according to the write-in controlling; and a main controller configured to record management information on the video data recorded on each storage device.

### CROSS-REFERENCE TO RELATED APPLICATIONS

This application is based upon and claims the benefit of priority from prior Japanese Patent Application No. 2011-197592, filed Sep. 9, 2011, the entire contents of which are incorporated herein by reference.

### FIELD

Embodiments described herein relate generally to a video server, video recording method and method for controlling rebuilding process.

### BACKGROUND

The digitization in the broadcast field is progressing for example digital terrestrial broadcasting. The digitized program data becomes large volume with extended definition of data. Multi-channel broadcasting system is realized with the spread of digital terrestrial broadcasting or BS (broadcasting satellite) broadcasts. For this reason, the video server which records these materials deal with the data of large volume and multi-channel. Then, the recording unit which stores the material in a video server is used increasingly with a flash memory which is reliable and random accessible.

By the way, two or more recording units are made to carry in the video server for improvement in the write-in performance to a recording unit, and the read-out performance from a recording unit. There is the method of accessing in parallel by distributing data to a plurality of these recoding units. As described above, if parity data is stored on one of these recoding units, even if it is a case where one of a plurality of recoding units breaks down, it is possible to restore the data of a lack part based on the data recorded on other recording units.

Rebuilding processing is performed when exchanging the broken recoding unit. A rebuilding processing is restoring the data currently recorded on the recoding unit before exchange based on the data recorded on other recoding units, and recording restored data on the recoding unit after exchanging the restored data. The recording unit after exchange cannot be driven until all the data currently recorded on the recording unit before exchanging is rebuilt to the recording unit after exchanging. However, rebuilding all the data takes time.

As mentioned above, in the conventional video server, it cannot drive until all the data currently recorded on the recording unit before exchange is rebuilt. And rebuilding all the data takes time.

### BRIEF DESCRIPTION OF THE VIEWS OF THE DRAWING

FIG. 1 is a figure showing the configuration of a video sending-out system including the video server according to the embodiment.

FIG. 2 is a block diagram showing the functional configuration of the video server in FIG. 1.

FIG. 3 is a figure showing generating division data and parity data and recording these on the recording unit in FIG. 2.

FIG. 4 is a figure showing restoring the broken data of a recording unit and generating the original video data.

FIG. 5 is a figure showing the rebuilding of the data of the recording unit before exchanging to the recording unit after exchanging based on the data of the recording unit of the non-exchanging.

FIG. 6 is a flow chart showing the recording processing performed by the main controller of the video server of FIG. 2.

FIG. 7 is a figure showing the management information table recorded on the memory in the main controller of FIG. 2.

FIG. 8 is a sequence showing the rebuilding processing by the video server of FIG. 2.

FIG. 9 is a table showing a correspondence relation with the address which records the video frame recorded on the memory of the recording unit of FIG. 2, and this video frame.

### DETAILED DESCRIPTION

In general and according to one embodiment, a video server including a recording device configured to encode a received video signal based on a predetermined encoding method into video data; a write controller configured to divide the video data in order to generate a plurality of divided data, generate a redundant data for restoring either of the divided data of the number of setup when the divided data of the number of setup in advance, perform write-in controlling of the plurality of divided data and the plurality of redundant data; a plurality of storage devices configured to record the number of setup of divided data and the redundant data based on the divided data of the number of setup by distributing herein according to the write-in controlling; and a main controller configured to record management information on the video data recorded on each storage device.

### First Embodiment

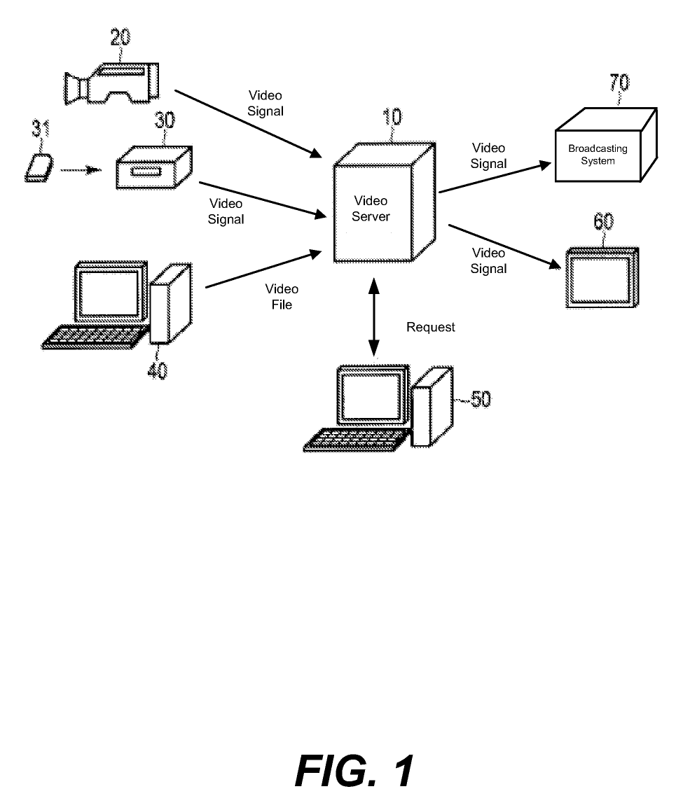

FIG. 1 shows the example of configuration of broadcasting system including the video server 10 according to the embodiment. The broadcasting system shown in FIG. 1 includes a video server 10, a video camera 20, a video player 30, a non-linear editor 40, an operation terminal 50, a monitor 60 for a video check, and a transmitting system 70.

The video camera 20 outputs the taken video signal to the video server 10.

The video player 30 is inserted into the video memory media 31 on which picture image data or a video file was recorded. Video data mean that by which the video signal was coded using the predetermined encoding method set up beforehand. A video file means the file from which video data were changed into the file format. The video player 30 reads the video data or video file from the video memory media 31, changes into a video signal from the read data, and outputs the video signal to the video server 10.

The non-linear editor 40 reads the video file stored in the video server 10 according to the demand from a user. The read video file is edited by the non-linear editor 40 based on user directions. The non-linear editor 40 outputs an edited video file to the video server 10.

The operation terminal 50 accepts the processing demand from a user, and in order to perform processing demanded by the user, the operation terminal 50 directs the operation terminal 50 to the video server 10. In this embodiment, the processing which a user demands means below processing; recording processing of a video signal, the playback processing of a video signal, rebuilding and the like. In addition, rebuilding processing means—when either of the recording units carried in the video server 10 is exchanged, processing reconstructs the data currently recorded on the recording unit for exchange based on the data recorded on the recording unit of the outside for exchange, and the processing recorded on the recording unit after exchange.

The monitor 60 for video check receives the video signal by which the video data or the video file stored in the video server 10 was played back. The monitor 60 for a video check displays the video signal received from the video server 10. A user checks the necessity for edit processing, etc. with reference to the video displayed on the monitor 60 for a video check.

The transmitting system 70 receives the video signal by which the video data or the video file stored to the video server 10 was played back. The transmitting system 70 transmits the video signal from the video server 10 towards the area which provides broadcast service.

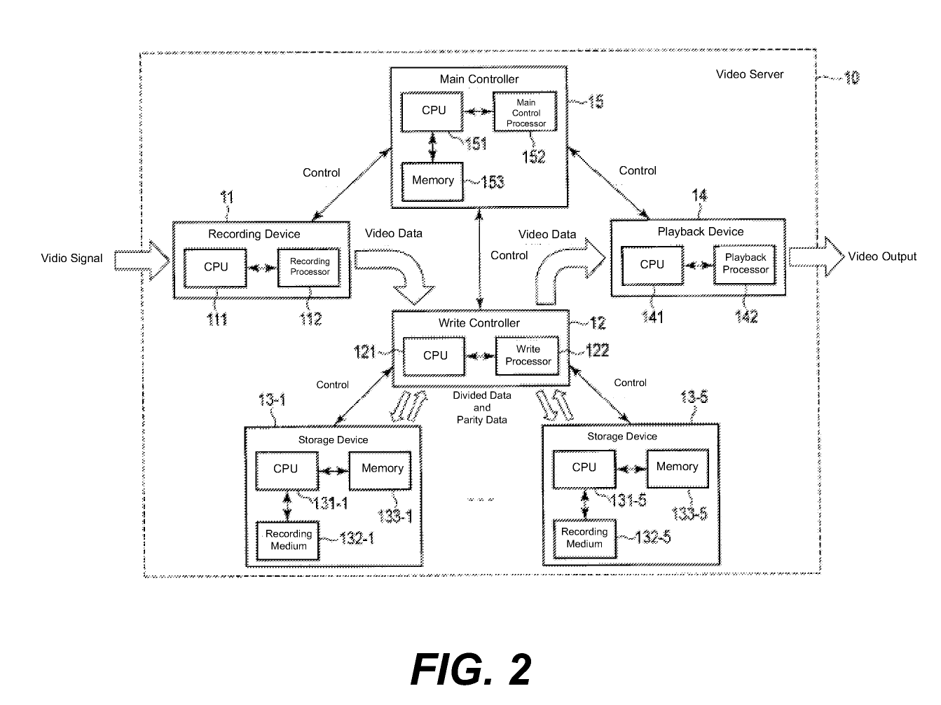

FIG. 2 is a block diagram showing the functional configuration of the video server 10 according to this embodiment. The video server 10 shown in FIG. 2 includes the recording device 11, the write controller 12, the storage device 13-1 to 13-5, the playback device 14, and the main controller 15.

The recording device 11 has CPU (Central Processing Unit) 111 and the recording processor 112. If recording directions are given from the main controller 15, CPU111 outputs directions, in order to process the video signal supplied from the outside to the recording processor 112. The recording processor 112 encodes a video signal into video data according to the encoding method set up in advance, if the directions from CPU111 are received. The encoding method set up in advance is for example an MPEG 2 (Moving Picture Experts Group 2) system and the like. The recording processor 112 outputs video data to the write controller 12.

The main controller 15 has a CPU151, a main control processor 152, and a memory 153. The main controller 15 controls the whole video server 10. If the CPU151 receives a recording request for recording the video signal, a playback request for playback the video signal, or a rebuilding from the operation terminal 50, CPU151 makes the main control processor 152 control the whole video server 10.

The main control processor 152 controls the recording device 11 and the write controller 12 in order to record a video signal, if CPU 151 receives the recording request. When the user of the operation terminal 50 gives a recording request to the video server 10, the user may input programmed playback time, a playback priority and the like regarding video signal. The CPU 151 records management information which is including a material ID of recorded video signal, frame length, programmed playback time, and playback priority, on the memory 153, if recording of a video signal is completed.

If the main control processor 152 receives the playback directions with which the video signal for a playback processing was specified, the main control processor 152 is controlled in order to reproduce the video signal specified in the write controller 12 and the playback device 14, the main control processor 152 controls the write controller 12 and the playback device 14 in order to play back the specified video signal. At this time, the main control processor 152 reads material ID and the frame length of a video signal which were specified, from the memory 153, and outputs the material ID and the frame length to the write controller 12.

If the CPU 151 receives the rebuilding request, the main control processor 152 determines the video data which should perform a rebuilding processing first with reference to the management information recorded on the memory 153. In order to perform the rebuilding processing of the determined video data, the main control processor 152 notifies material ID and the frame length of video data which were determined, then the main control processor 152 performs the rebuilding processing to the write controller 12.

The management information referred to when determining the video data which carry out a rebuilding processing includes recording time, programmed playback time, a playback priority and the like. For example, the main control processor 152 makes the rebuilding processing of video data performs at the write controller 12 in the recorded order with reference to recording time. The main control processor 152 may make the rebuilding processing of video data perform in order with early time played back with reference to programmed playback time at the write controller 12. The main control processor 152 may make the rebuilding processing of video data carry out to an order that the priority played back is high, with reference to a playback priority at the write controller 12.

The write controller 12 has a CPU121 and a write processor 122. If the CPU 121 is controlled in order to record by the main controller 15, the CPU 121 outputs directions to the write processor 122 so that the video data from the recording device 11 may be processed, the CPU 121 outputs directions of processing the video data from the recording device 11 to the write processor 122.

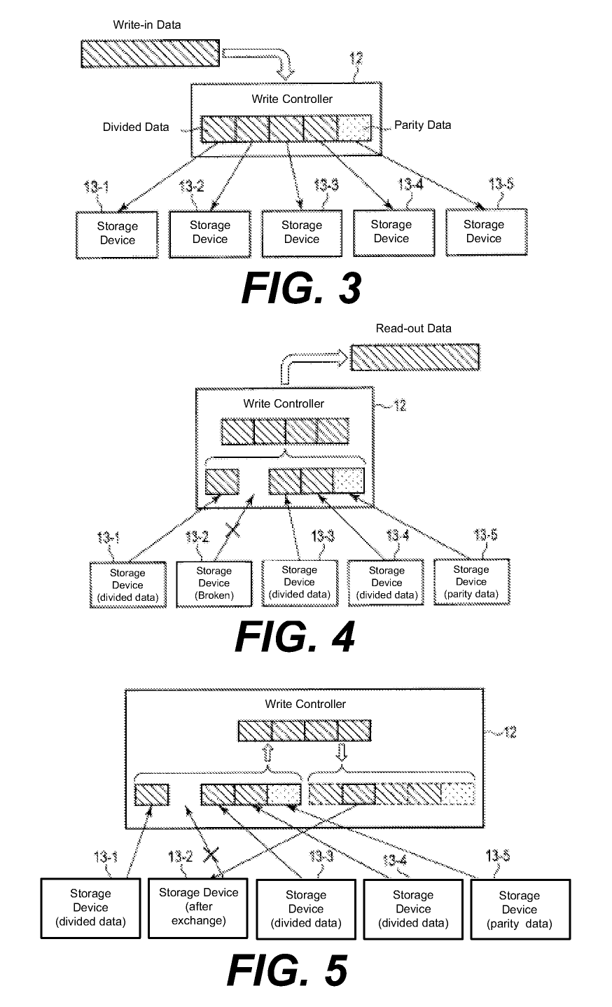

According to the directions from the CPU 121, the write processor 122 divides the video data from the recording device 11 for every predetermined size, and generates a plurality of divided data. The size of divided data is set up according to the write-in capability of the data to the storage device 13-1 to 13-5. Whenever the write processor 122 divides four divided data from video data, the write processor 122 generates the parity data which is redundant data for restoring these four divided data. The write processor 122 performs parallel write-in controlling at the storage device 13-1 to 13-5. That is, the write processor 122 outputs four divided data and one parity data to the storage device 13-1 to 13-5 in parallel. The write processor 122 repeats the output of four divided data and one parity data from the head frame of the video data to the last frame. The write processor 122 changes suitably the output place of four divided data and one parity data in order to avoid that parity data is recorded only on one specific storage device in the storage device 13-1 to 13-5. FIG. 3 shows the processing which records the divided data and parity data in which the write processor 122 generated and generated divided data and parity data based on video data on the storage device 13-1 to 13-5.

If playback control is performed by the main controller 15, the CPU 121 outputs directions to the write processor 122 so that video data may be made to read from the storage device 13-1 to 13-5. According to the directions from the CPU 121, the write processor 122 performs read-out controlling to the storage device 13-1 to 13-5 in parallel. The write controller 122 notifies material ID and the frame length which were notified from the main controller 15 to the storage device 13-1 to 13-5. The write processor 122 receives the divided data and parity data which are outputted according to this read-out controlling from the storage device 13-1 to 13-5.

When the write processor 122 receives four divided data normally in parallel, the write processor 122 combines four received divided data to generate the video data, and outputs the video data to the playback device 14. When either has an error among the received divided data, or when either of the divided data is not able to be received, the write processor 122 restores normal divided data based on three divided data and the parity data which were received normally. The write processor 122 outputs the video data which combined and generated three divided data and the divided data restored in order to generate video data to the output unit 14. FIG. 4 is a figure for explaining the case where the storage device 13-2 breaks down. That is, when the write controller 12 is not able to receive the divided data currently recorded on the storage device 13-2, the write controller 12 restores the divided data which disappeared using three divided data and one parity data which are recorded on the storage device 13-1, 13-3, and 13-4.

When rebuilding control is performed by the main controller 15 to the CPU 121, the CPU 121 outputs directions to the write processor 122 so that the data currently recorded on the storage device before exchange may be made to record on the storage device after reconstructing and exchanging the rebuilt data. The write processor 122 notifies material ID and the frame length which are notified from the main controller 15 to the storage device which are not exchanged. The write processor 122 performs read-out controlling for a rebuilding in parallel to the storage device which is not exchanged. The write processor 122 receives the divided data and the parity data which are outputted according to the read-out controlling for this rebuilding from the storage device which are not exchanged.

The write processor 122 combines these four divided data, in order to generate the original video data, when four divided data received from the storage device, which are not exchanged in parallel. When the write processor 122 receives three divided data and one parity data from the storage device which are not exchanged, the write processor 122 restores the divided data currently recorded on the storage device for exchange from these received data. That is, the write processor 122 combines three divided data and the restored divided data, in order to generate the original video data.

The write processor 122 divides video data for every predetermined size, if the original video data are generated. Whenever the write processor 122 generates four divided data from video data, the write processor 122 generates parity data. The write processor 122 performs write-in controlling for a rebuilding to the storage device after exchange. That is, the write processor 122 outputs the divided data and parity data which were recorded on the storage device before exchange to the storage device after exchange. FIG. 5 shows the rebuilding processing after exchanging the storage device 13-2 by the write controller 12. That is, the write controller 12 reconstructs the data before exchanging for the storage device 13-2 after exchange using the divided data and parity data recorded on the storage device 13-1, 13-3 to 13-5.

The storage device 13-1 to 13-5 has a CPU 131-1 to 131-5, the recording medium 132-1 to 132-5, and the memory 133-1 to 133-5. Since operation of the recoding unit 13-1 to 13-5 is the same respectively, below, it explains the recoding unit 13-1

The CPU 131-1 searches the vacant address in the recording medium 132-1, if write-in controlling is performed from the write controller 12. The CPU 131-1 writes the divided data or parity data supplied from the write controller 12 in the storage area pinpointed by the address searched among the storage areas of the recording medium 132-1. The CPU 131-1 relates the video frame corresponding to the recorded divided data to the address which recorded these divided data, and the CPU 131-1 records the related information on the memory 133-1.

The CPU 131-1 searches the address which records the video data specified by material ID and the frame length which were notified with reference to the memory 133-1, if material ID and frame length are notified from the write controller 12 while read-out controlling is performed from the write controller 12. The CPU 131-1 reads divided data or parity data from the storage area pinpointed by the address searched among the storage areas of the recording medium 132-1. The storage device 13-1 outputs the divided data or parity data read from the recording medium 132-1 to the write controller 12.

When the storage device 131-1 is a storage device which is not exchanged, if material ID and frame length are notified while read-out controlling for a rebuilding is performed from the write controller 12, the CPU 131-1 searches the address which records the video data specified by material ID and the frame length which were notified with reference to the memory 133-1. The CPU131-1 reads divided data or parity data from the storage area pinpointed by the address searched among the storage areas of the recording medium 132-1. The storage device 13-1 outputs the divided data or parity data read from the recording medium 132-1 to the write controller 12.

When the storage device 13-1 is a storage device after exchange, the CPU 131-1 searches the vacant address in the recording medium 132-1, if write-in controlling for the rebuilding from the write controller 12 is performed. The CPU 131-1 writes the divided data or parity data supplied from the write controller 12 in the storage area pinpointed by the address searched among the storage areas of the recording medium 132-1. The CPU 131-1 relates the video frame corresponding to the recorded divided data to the address which recorded these divided data, and the CPU 131-1 records it on the memory 133-1.

The playback device 14 has a CPU 141 and a playback processor 142. If playback control is performed by the main controller 15, the CPU 141 outputs directions so that the video data supplied from the write controller 12 may be made to process to the playback processor 142. If the playback processor 142 receives the directions from the CPU 141, the playback processor 142 decodes the video data supplied from the write controller 12 by the method corresponding to the encoding method in the recording device 11. Thereby, the video signal is generated. The playback processor 142 outputs the generated video signal to the exterior.

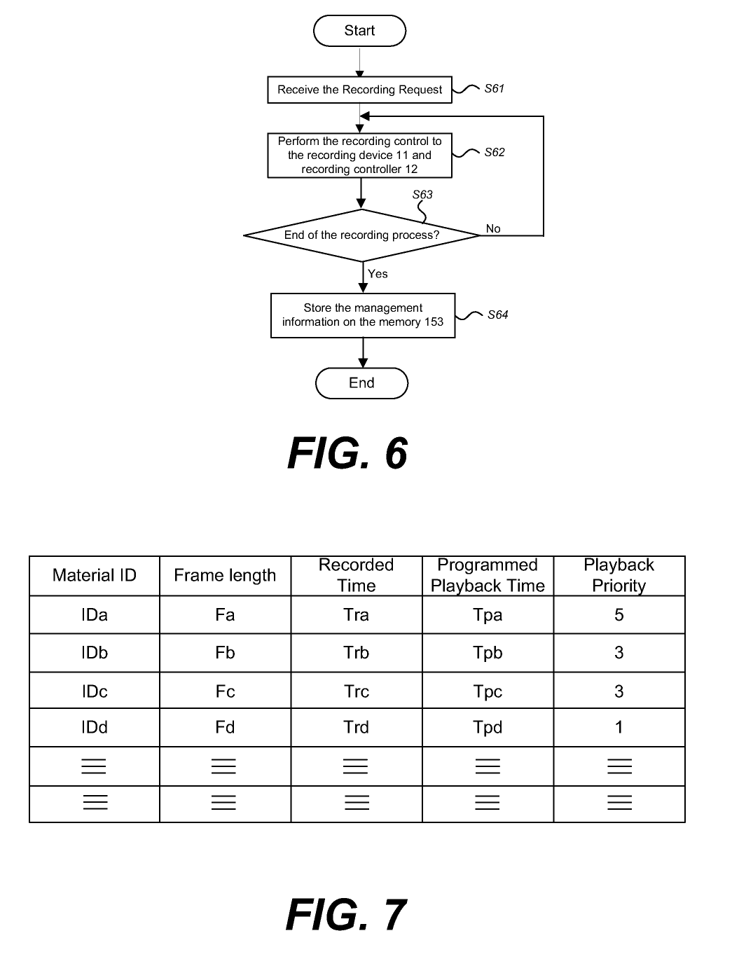

Next, the recording processing and the rebuilding processing of the video server 10 which were constituted as mentioned above are explained in detail. FIG. 6 is a flow chart which shows processing of the main controller 15 in the video server 10 according to the embodiment performing recording processing.

First, the main controller 15 receives a recording request from the operation terminal 50 (Step S61). The main controller 15 performs control for recording a video signal to the recording device 11 and the write controller 12, if a recording request is received (Step S62).

Then, the main controller 15 determines if the recording processing from the head frame of a video signal to the last frame ended (Step S63). When the recording processing is not completed (No of Step S63), the main controller 15 shifts processing to Step S62, and continues recording control. When the recording processing is completed (Yes of Step S63), the main controller 15 stores management information, including material ID of the recorded video signal, frame length, recording time, programmed playback time, a playback priority and the like on the memory 153 (Step S64). FIG. 7 is a figure showing an example of the management information table recorded on the memory 153.

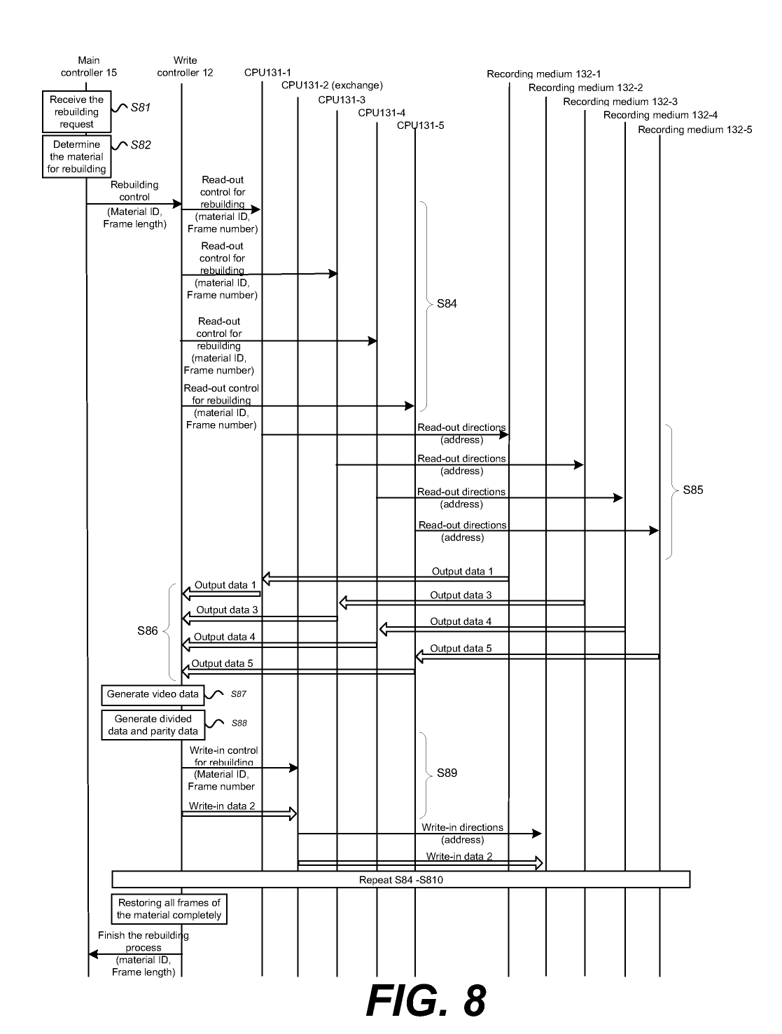

FIG. 8 is a sequence figure of the video server 10 according to the embodiment performing a rebuilding processing. In addition, FIG. 8 explains the case where it is exchanged in the storage device 131-2, as shown in FIG. 5.

First, the main controller 15 receives a rebuilding request from the operation terminal 50 (sequence S81). The main controller 15 chooses video data A which is “5” with the highest playback priority with reference to the management information table recorded on the memory 153 (sequence S82). The main controller 15 notifies material ID:IDa of video data A, and frame length: Fa to the write controller 12, and performs control for a rebuilding to the write controller 12 (sequence S83).

The write controller 12 notifies material ID:IDa and frame length:Fa which are notified from the main controller 15 to the storage device 13-1 which are not exchanged and 13-3 to 13-5, the write controller 12 performs the read-out controlling for the rebuilding to the storage device 13-1 and 13-3 to 13-5, in parallel (sequence S84).

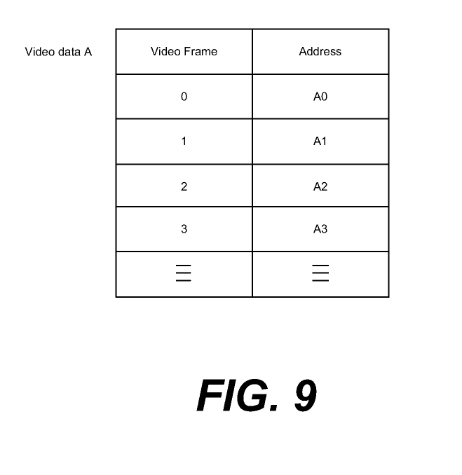

The storage device 13-1, CPU131-1, 131-3 of 13-3 to 13-5-131-5 performs the read-out controlling for a rebuilding by the write controller 12. The storage device 13-1, CPU131-1, 131-3 of 13-3 to 13-5-131-5 searches the address on which video-data A is recorded with reference to the memory 133-1, 133-3 to 133-5, if material ID:IDa and frame length:Fa are notified. FIG. 9 is a figure showing an example of the table which relates the address on which the video frame to this video frame of video data A recorded on the memory 133-1, 133-3 to 133-5 are recorded. The CPU 131-1, 131-3-131-5 controls the recording medium 132-1, 132-3 to 132-5 to make divided data or parity data read from the storage area pinpointed by the searched address (sequence S85).

The recording medium 132-1, 132-3 to 132-5 reads the divided data or the parity data recorded on the specified storage area according to the read-out directions from CPU131-1, 131-3-131-5. The storage device 13-1 and 13-3 to 13-5 output four divided data read from the recording medium 132-1, 132-3 to 132-5, or three divided data and one parity data to the write controller 12 (sequence S86).

If the write controller 12 receives four divided data from the storage device 13-1 and 13-3 to 13-5, the write controller 12 combines these four divided data, in order to generate the original video data. If the write controller 12 receives three divided data and one parity data from the storage device 13-1, 13-3 to 13-5, the write controller 12 restores the divided data from these received data. The write controller 12 combines three divided data and the restored divided data, in order to generate the original video data (sequence S87).

The write controller 12 generates divided data and parity data based on the video data of the generated origin (sequence S88). The write controller 12 outputs the divided data or the parity data currently recorded on the storage device before exchange to the storage device 13-2 while performing control which writes in the data restored to the storage device 13-2 after exchange (sequence S89).

If the CPU 131-2 has the write-in controlling for a rebuilding performed by the write controller 12, the CPU 131-2 searches the vacant address in the recording medium 132-2. The CPU 131-2 outputs write-in directions to the recording medium 132-2 so that the recording medium 132-2 writes in the divided data or the parity data supplied to the storage area pinpointed by the searched address from the write controller 12. The CPU 131-2 outputs divided data or the parity data (sequence S810). The recording medium 132-2 writes in the divided data or the parity data supplied to the specified storage area according to the write-in directions from the CPU 131-2.

The write controller 12 and the storage device 13-1 to 13-5 repeat the sequence S84—the sequence S810 until rebuilding from the head frame of video data A selected by the sequence S82 to the last frame is completed. After rebuilding of video data A is completed, the write controller 12 notifies the main controller 15 that the rebuilding processing was completed while notifying material ID and the frame length of video data A to the main controller 15. Thus, the rebuilding processing is performed for every video data recorded on the storage device 13-1 to 13-5.

As mentioned above, in the video server 10 according to the embodiment, the main controller 15 records material ID, frame length, recording time, a programmed playback time, a playback priority and the like of the video signal to record. When performing a rebuilding processing, the main controller 15 chooses the video data reconstructed to the beginning among the plurality of video data recorded on a storage device with reference to management information. And the write controller 12 performs a rebuilding processing preferentially to video data with the selected main controller 15. Thereby, the video server 10 can perform the rebuilding processing of video data in arbitrary order.

Moreover, in the video server 10 according to the embodiment, the main controller 15 also includes and records recording time on management information at the time of recording of video data. Thereby, as for the main controller 15, it is possible to make a rebuilding processing perform in an order that video data were recorded.

Moreover, in the video server 10 according to the embodiment, programmed playback is received from the operation terminal 50. When recording video data, the main controller 15 also includes and records this programmed playback on management information. Thereby, as for the main controller 15, it is possible to make the rebuilding processing of video data perform in order of the schedule played back for broadcast. Moreover, it is possible to perform a rebuilding processing only to the material for which the programmed playback is performed.

Thus, a configuration which reconstructs for every material makes it possible to perform a rebuilding processing in an order based on various priorities.

Therefore, according to the embodiment, it makes it unnecessary to wait for all the data currently recorded on the storage device before exchange to rebuild them, since the video data which are needed previously among the video data currently recorded on the storage device before exchange rebuilt immediately. That is, even if not all the data currently recorded on the storage device before exchange rebuilds, the storage device after exchange can be made to drive.

In addition, the embodiment is explained as follows, for example, when the rebuilding request was received, the main controller 15 chooses the video data by a rebuilding processing having priority with reference to a management information table. However, it is not necessarily limited to above. For example, while the main controller 15 performs rebuilding control to the write controller 12, the main controller 15 may make it output a management information table to the write controller 12, if a rebuilding request is received. At this time, the write controller 12 has the memory 123, and records the management information table supplied from the main controller 15 on the memory 123. The write controller 12 chooses the video data which have priority and performs a rebuilding processing with reference to a management information table, if rebuilding control is received from the main controller 15. And the write controller 12 controls a storage device to perform the rebuilding processing of selected video data. The above configurations make it possible to close and perform a rebuilding processing in the write controller 12 and the storage device 13-1 to 13-5. That is, it makes it possible to make unnecessary the determination of the rebuilding material in the main controller 15, and directions of the rebuilding material from the main controller 15. Therefore, it makes it possible to reduce the load at the time of the rebuilding processing of the main controller 15.

Moreover, the case where the video server 10 included the storage device 13-1 to 13-5 was explained to the embodiment as an example. However, it is not necessarily limited to this. For example, a storage device is not necessarily limited to five pieces. If the storage device can record the divided data and the parity data in parallel, the storage device may be five or less pieces, or may be above.

While certain embodiments have been described, these embodiments have been presented by way of example only, and are not intended to limit the scope of the inventions. Indeed, the novel embodiments. described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video server, comprising:
a recording device configured to encode a video signal into video data based on a predetermined encoding method;
a write controller configured to divide the video data into a plurality of divided data, generate redundant data for restoring the divided data, and perform write control of the plurality of divided data and the plurality of redundant data;
a plurality of storage devices configured to record the divided data and the redundant data, the divided data distributed across the plurality of storage devices according to the write control performed by the write controller; and
a main controller configured to record management information associated with the video data recorded on each storage device.

2. The video server of claim 1, wherein, if one of the plurality of storage devices is to be exchanged with a replacement storage device,
the main controller selects priority video data to be reconstructed by choosing a segment of video data among the video data recorded on the plurality of storage devices based on priority information in the management information; and
the write controller reads the selected priority video data recorded on each storage device except for the storage device to be exchanged, generates the divided data and the redundant data which were recorded on the storage device to be exchanged based on the read selected priority video, and writes the divided data and the redundant data to the replacement storage device.

3. The video server of claim 1, wherein,
the management information comprises a recording time, a material ID, and a frame length for the recorded video data, and
the main controller is configured to select the priority video data based at least in part on the recording time.

4. The video server of claim 2, wherein,
the management information comprises a programmed playback time, a material ID, and a frame length of video data; and
the main controller is configured to select the priority video data based at least in part on the programmed playback time.

5. The video server of claim 2, wherein,
the management information comprises a playback priority, a material ID, and a frame length of video data; and
the main controller is configured to select the priority video data based at least in part on the playback priority.

6. The video server of claim 1, wherein, if one of the plurality of storage devices is exchanged,
the main controller outputs the management information to the write controller,
the write controller selects priority video data to be reconstructed by choosing a segment of video data among the video data recorded on the plurality of storage devices based on the management information; and
the write controller reads the selected priority video data recorded on each storage device except for the storage device to be exchanged, generates the divided data and the redundant data which were recorded on the storage device to be exchanged based on the read selected priority video, and writes the divided data and the redundant data to the replacement storage device.

7. The video server of claim 6, wherein,
the management information comprises a recording time, a material ID, and a frame length for the recorded video data, and
the priority video data is selected based at least in part on the recording time.

8. The video server of claim 6, wherein,
the management information comprises a programmed playback time, a material ID, and a frame length of video data; and the priority video data is selected based at least in part on the programmed playback time.

9. The video server of claim 2 wherein the priority video data to be selected to be reconstructed can be located at any memory location within the plurality of storage devices.

10. A video recording method, comprising,
generating a video data by encoding a received video signal based on a predetermined encoding method;
generating divided data by dividing the video data;
generating redundant data for restoring the divided data;
writing the divided data and the redundant data to a plurality of storage devices; and
recording management information of the video data.

11. The method of claim 10, wherein, if one of the plurality of storage devices is to be exchanged with a replacement storage device,
selecting a priority video data to be reconstructed by choosing a segment of video data among the video data recorded on the plurality of storage devices based on priority information in the management information;
reading the selected priority video data recorded on each storage device except for the storage device to be exchanged;
generating the divided data and the redundant data which were recorded on the storage device to be exchanged based on the read selected priority video; and
writing the divided data and the redundant data to the replacement storage device.

12. The method of claim 11 wherein the priority video data to be selected to be reconstructed can be located at any memory location within the plurality of storage devices.

13. The method of claim 11, wherein,
the management information comprises a recording time, a material ID, and a frame length for the recorded video data, and
the priority video data is selected based at least in part on the recording time.

14. The method of claim 11, wherein,
the management information comprises a programmed playback time, a material ID, and a frame length of video data; and
the main controller is configured to select the priority video data based at least in part on the programmed playback time.

15. The method of claim 11, wherein,
the management information comprises a playback priority, a material ID, and a frame length of video data; and
the main controller is configured to select the priority video data based at least in part on the playback priority.

16. A method rebuilding video in a video server comprising,
determining that a storage device among a plurality of storage devices requires exchanging with a replacement storage device;
choosing a priority video data for reconstructing based on management information recorded when video data was recorded;
reading video data recorded on the plurality of storage device other than the storage device that requires exchanging corresponding to the priority video data;
generating divided data and redundant data which were recorded on the storage device requiring exchange based on the recorded video data; and
writing the generated dividing data and the generated redundant data on the replacement storage device.

17. The method of claim 16, wherein,
the management information comprises a recording time, a material ID, and a frame length for the recorded video data, and
the priority video data is selected based at least in part on the recording time.

18. The method of claim 16, wherein,
the management information comprises a programmed playback time, a material ID, and a frame length of video data; and
the main controller is configured to select the priority video data based at least in part on the programmed playback time.

19. The method of claim 16, wherein,
the management information comprises a playback priority, a material ID, and a frame length of video data; and
the main controller is configured to select the priority video data based at least in part on the playback priority.

20. The method of claim 16 wherein the priority video data chosen to be reconstructed can be located at any memory location within the plurality of storage devices.
